(19) United States
(12) Patent Application Publication
(10) Pub. No.: US 2011/0257795 A1
(43) Pub. Date: Oct. 20, 2011

(54) THERMOSTAT METHOD AND SYSTEM FOR CONTROLLING SOLAR ENERGY UTILIZATION FOR EFFICIENT ENERGY USAGE AND CONSERVATION OF ENERGY RESOURCES

(75) Inventors: Ramachandran NARAYANAMURTHY, El Cerrito, CA (US); Joshua R. PLAISTED, Oakland, CA (US)

(73) Assignee: PVT Solar, Inc., Fremont, CA (US)

(21) Appl. No.: 13/168,901

(22) Filed: Jun. 24, 2011

(51) Int. Cl. G06F 1/32; G05D 23/19; E04D 13/18

(52) U.S. Cl. 700/277

(57) ABSTRACT

A system for controlling solar energy utilization for efficient energy usage and conservation of energy resources for providing space conditioning and home ventilation. The system includes a control module configured to operate a solar energy system for collecting a flow of fresh air for utilizing thermal energy converted by the solar energy system. Additionally, the system includes a thermostat module directly coupled with an HVAC system to for controlling a delivery of a conditioned airflow. The thermostat device couples wirelessly to the control module. Further, the system includes a graphic user interface operably communicating with the control module remotely via a network hub. The graphic user interface device is configured to set modes of operation for the thermostat module and configured to communicate with the thermostat module for transmitting control information, modes of operation, and temperature information of the building structure to the control module via a wireless transmission.

### CROSS-REFERENCES TO RELATED APPLICATIONS

Not Applicable

### STATEMENT AS TO RIGHTS TO INVENTIONS MADE UNDER FEDERALLY SPONSORED RESEARCH AND DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention relates to solar energy application for efficient energy usage and conservation of energy sources for homes. More particularly, the present invention provides a thermostat method and system for controlling a solar energy system coupled with a HVAC system for healthy home ventilation and space conditioning. Merely, by way of example, the present invention provides a control method for operating the solar energy system coordinated with the HVAC system to utilize solar energy for space conditioning and home ventilation, but it would be recognized that the invention has a much broader range of applications.

Over the past centuries, the world population of human beings has exploded. Along with the population, demand for resources has also grown explosively. Such resources include raw materials such as wood, iron, and copper and energy, such as fossil fuels, including coal and oil. Industrial countries worldwide project more increases in oil consumption for transportation and heating purposes from developing nations such as China and India. Obviously, our daily lives depend, for the most part, upon oil or other forms of fossil fuel, which are becoming scarce as it becomes depleted.

Along with the depletion of our fossil fuel resources, our planet has experienced a global warming phenomena, known as “global warming,” and brought to our foremost attention by our former Vice President Al Gore. Global warming is known as an increase in an average temperature of the Earth's air near its surface, which is projected to continue at a rapid pace. Warming is believed to be caused by greenhouse cases, which are derived, in part, from use of fossil fuels. The increase in temperature is expected to cause extreme weather conditions and a drastic size reduction of the polar ice caps, which in turn will lead to higher sea levels and an increase in the rate of warming. Ultimately, other effects include mass species extinctions, and possibly other uncertainties that may be detrimental to human beings.

Much if not all of the useful energy found on the Earth comes from our sun. Generally all common plant life on the Earth achieves life using photosynthesis processes from sun light. Fossil fuels such as oil were also developed from biological materials derived from energy associated with the sun. For life on the planet Earth, the sun has been our most important energy source and fuel for modern day solar energy. Solar energy possesses many characteristics that are very desirable! Solar energy is renewable, clean, abundant, and often widespread. Accordingly, solar panels have been developed to convert sunlight into energy. Most solar energy systems today use “PV” technology. They convert sunlight directly into the electricity that you use to light your home, or power your appliances. As merely another example, solar thermal panels also are developed to convert electromagnetic radiation from the sun into thermal energy for heating homes, running certain industrial processes, or driving high grade turbines to generate electricity. In fact, solar photovoltaic panels also generate heat as a side product. Solar panels are generally composed of an array of solar (PV and/or thermal) cells, which are interconnected to each other. The cells are often arranged in series and/or parallel groups of cells in series. Accordingly, solar panels have great potential to benefit our nation, security, and human users. They can even diversify our energy requirements and reduce the world's dependence on oil and other potentially detrimental sources of energy.

Although solar panels have been used successful for certain applications, there are still certain limitations. Solar cells are often costly. Depending upon the geographic region, there are often financial subsidies from governmental entities for purchasing solar modules, which often cannot compete with the direct purchase of electricity from public power companies. Additionally, most PV solar energy systems only utilize about 15% of the captured sun's energy. The remaining energy, mostly in the form of heat or thermal energy, remains untapped. Moreover, conventional solar energy systems are also difficult to maintain and monitor for operational accuracy. Once a solar energy system has been installed, there is simply no easy way to monitor the accuracy of energy production. In particular, as the solar energy system works together with other traditional building utility modules such as water heating, home heating, home cooling, and ventilation, there are lacks in methods and apparatus for providing optimized control of the solar energy system to be without conflict with the operation of one or more auxiliary thermal systems including a HVAC system to efficiently utilize solar thermal energy for providing space conditioning and ventilation to a building structure or home dwelling. These and other limitations are described throughout the present specification, and may be described in more detail below.

From the above, it is seen that techniques for improving operation of an integrated solar energy system are highly desired.

### BRIEF SUMMARY OF THE INVENTION

The present invention relates to solar energy application for homes. More particularly, the present invention provides a thermostat method and system for controlling solar energy utilization for a healthy home. Merely, by way of example, the present invention provides a control module forming a local wireless network with a thermostat for operating the solar energy system in coordination with an HVAC system to utilize solar energy for space conditioning and home ventilation, but it would be recognized that the invention has a much broader range of applications.

In a specific embodiment, the present invention provides a system for controlling solar energy utilization for efficient energy usage and conservation of energy resources. The system includes a control module configured to control operation of a solar energy system associated with a building structure for providing a flow of fresh air and thermal energy converted from a solar energy source by the solar energy system. The system further includes a thermostat module disposed in the building structure to transfer signals to an HVAC system coupled with the solar energy system. The solar energy system is configured to transfer the flow of fresh air for space use of a first selected portion of the building structure and configured for ventilation of a second selected portion of the building structure. The thermostat module includes a wireless device for transmitting temperature information to the control module via a wireless signal. The control module is substantially free from direct communication with the HVAC system. Additionally, the system includes a graphic user interface device operably communicating with the control module remotely via a network hub. The network hub is coupled to an external network of computers. The graphic user interface device is configured to set modes of operation for the thermostat module and configured to communicate with the thermostat module for transmitting control information, modes of operation, and temperature information of the building structure to the control module via a wireless transmission.

In another specific embodiment, the present invention provides a method for coordinating a solar energy system with a HVAC system for providing healthy home space conditioning and ventilation. The method includes providing a control module for a solar energy system associated with a home. The method further includes disposing a thermostat device in the home for controlling a HVAC system. The thermostat device includes a wireless device. Additionally, the method includes forming a local wireless network between the control module and the thermostat device via the wireless device. The method further includes initiating a graphic user interface for inputting control information. The graphic user interface is linked to a network hub that includes a data server configured to transfer the control information to the control module via Ethernet or Internet. The control information is partially executed by the solar energy system for providing space conditioning and ventilation. Furthermore, the method includes transferring selected control information using the local wireless network from the control module to define modes of operation for the thermostat device. The modes of operation are executed by the HVAC system for providing auxiliary space conditioning. The method further includes receiving at the control module a space condition information from the thermostat device using the local wireless network. Moreover, the method includes configuring the HVAC system and the solar energy system using the selected control information and the space condition information in a coordinated process within a defined time period. The coordinated process includes communicating the selected control information between the control module and the graphical user interface and updating the selected control information, if the selected control information has been changed based on the space condition information received at the control module or inputted at the graphical user interface, to maintain the same updated control information at the graphical user interface, the control module, and the data server. In an embodiment, the defined time period is about fifteen minutes and less.

In yet another specific embodiment, the present invention provides a method of forming a local wireless network between the control module and the thermostat device. The method includes configuring the thermostat device in a mode of operation with an enabled function for wireless communication and remotely controlling the thermostat device via a graphic user interface associated with the control module. The method further includes a sequence of steps for commissioning the thermostat device: a step of powering down both the control module and the thermostat device, a step of inserting a Zigbee U-snap module to the thermostat device; a step of inserting a battery to the thermostat device; a step of inserting a Zigbee USB stick to the control module; a step of powering up the control module; a step of forming a Zigbee network between the control module and the thermostat device; a step of validating the Zigbee network; a step of closing the Zigbee network; and a step of enabling the thermostat device by using the Zigbee network from the graphic user interface associated with the control module.

Many benefits are achieved by way of the present invention over conventional techniques. For example, the present technique provides an easy to use process that relies upon a solar energy system made by a combination of solar PV modules and solar thermal modules for producing electric and thermal energy out of solar energy sources. In a specific embodiment, a control system for operating the solar energy system integrated with a heating, ventilation, and air conditioning (HVAC) system for providing economic space conditioning and home ventilation with optimized utilization of solar energy and conservation of energy resources. Additionally, the present invention provides a coordinated control method for both the solar energy utilization and home space conditioning/ventilation application using a graphic user interface communicating with a control module via a network hub connected to world wide network of computers and using a local wireless network formed between the control module for controlling the solar energy system and a thermostat device disposed in the target home for controlling the HVAC system. One of the advantages lies on allowing users or home owners to remotely input control settings to define temperature setpoints for the thermostat device for operating the HVAC system or to adjust a comfort band for operating the solar energy system without causing any conflict in operation modes. In a specific embodiment, the comfort band is set such that the solar energy system is initiated for providing a flow of fresh air for space conditioning and ventilation before the HVAC system is initiated to provide a conditioned airflow with substantially reduction in energy usage and conservation of energy resources. The present invention also provides an advanced virtual thermostat within the graphic user interface including a plurality of programming codes that provide intuitive control settings and scheduling to provide optimized control over the space conditioning and home ventilation, with benefits in improved energy efficiency, less costly, and easy to manage as a healthy home system. In another specific embodiment, the energy production by the solar energy system, the energy transfer process, and thermal energy utilization through various auxiliary thermal systems can be remotely controlled using the graphic user interface linked to the control module and updated within a predetermined time period by receiving updated home space condition information from the wirelessly connected thermostat device in the target home. Depending upon the embodiment, one or more of these benefits may be achieved. These and other benefits will be described in more detail throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of a system for controlling solar energy utilization for a healthy home according to an embodiment of the present invention.

FIG. 2 is a display view of a graphic user interface home page for controlling a solar energy system coupled with a HVAC system according to an embodiment of the present invention.

FIG. 3 is a display view of a virtual thermostat page from the graphic user interface home page in FIG. 2 according to the embodiment of the present invention.

FIG. 4 is a display view of an advanced calendar setting window from the virtual thermostat page in FIG. 3 according to the embodiment of the present invention.

FIG. 5 is a simplified flow diagram illustrating a method of controlling an operation of a solar energy system in coordination of an operation of a HVAC system for providing ventilation and space conditioning according to an embodiment of the present invention.

### DETAILED DESCRIPTION OF THE INVENTION

The present invention relates to solar energy application for home space conditioning and ventilation. More particularly, the present invention provides a thermostat method and system for controlling solar energy utilization for a healthy home. Merely, by way of example, the present invention provides a control module forming a local wireless network with a thermostat for operating the solar energy system coordinated with an HVAC system to utilize solar energy for space conditioning and home ventilation, but it would be recognized that the invention has a much broader range of applications.

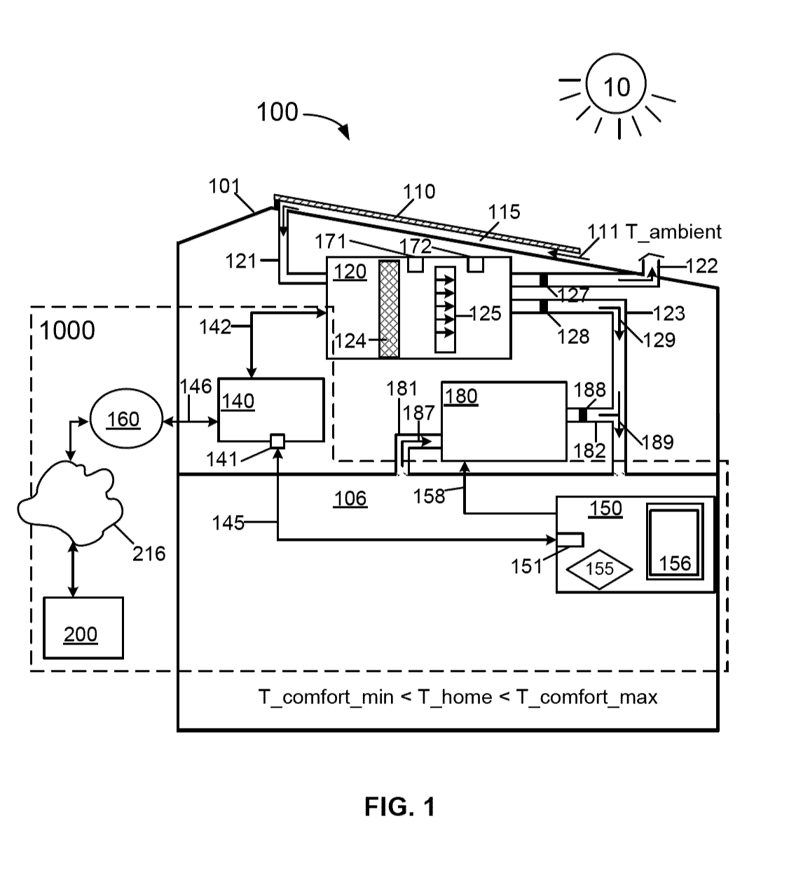

FIG. 1 is a simplified diagram of a system for controlling solar energy utilization for a healthy home according to an embodiment of the present invention. This diagram is merely an example, which should not unduly limit the scope of the claims herein. One of ordinary skill in the art would recognize other variations, modifications, and alternatives. It is also understood that the examples and embodiments described herein are for illustrative purposes only and that various modifications or changes in light thereof will be suggested to persons skilled in the art and are to be included within the spirit and purview of this process and scope of the appended claims.

As shown, a control system 1000 is configured to control operation of a solar energy system 100 in association with a target building structure or home dwelling 101 for providing space conditioning and ventilation with optimized utilization of solar energy generated by the solar energy system in coordination with thermal energy generation using conventional auxiliary thermal systems. The control system 1000 includes essentially a graphic user interface 200 communicated with a control module 140 which wirelessly couples to a thermostat device 150. The control system 1000 is configured to perform multiple operational controls over the solar energy system 100 through the control module 140 and also perform a coordinated operational control through the thermostat device 150 over an HVAC system 180 that is integrated within the solar energy system 100. The graphic user interface 200 can be initiated in any physical computing device that is linked with the control module 140 through a network hub 160. The computing device can be any one of various types of server computer or personal computer or smart phone, such as desktop computer, laptop computer, hand-held computer, tablet computer, iPhone or Blackberry type of smart phones with different operating systems (Unix, Windows, Adroid, Apple iOS, Linux or other open source operating systems). The network hub 160 including a data server that receives and stores information inputted through the graphic user interface 200 and is configured to communicate with the control module 140 via an Ethernet or Internet connection 216 to update the information with the control module. In an embodiment, the computing device loaded with the graphic user interface 200 is located remotely relative to the target home 101 and connected to an external or a world-wide network of computers via the Internet connection 216. The control module 140 is updated with the information inputted through the graphic user interface 200 within a predetermined time period, e.g., every 15 minutes. In another embodiment, the control module 140 is coupled with the thermostat device 150 via a local Zigbee wireless network 145 dedicated for both and closed for any other wireless devices.

In an embodiment, the solar energy system 100 includes a solar module 110 installed on a roof of the home dwelling 101 and includes an energy transfer module 120 coupled to the solar module 110 for utilizing both electrical and thermal energy converted from solar power of sun 10. In particular, the solar module 110 is a combination of one or more solar thermal modules converting solar energy directly to thermal energy and one or more photovoltaic (PV) modules providing thermal energy as a side product while generating electric power. The solar energy system 100 further includes a plenum structure 115 formed directly underneath the solar module 110. The plenum structure 115 is configured to draw a flow of fresh air 111 from ambient allowing the flow to pass across the whole bottom face of the solar module 110 before being guided to an air inlet 121. When the solar module 110 is in an active mode of solar energy production, thermal energy is also generated and can be carried at least partially by the flow of fresh air 111. The flow of fresh air 111 is further received by the energy transfer module 120 via the air inlet 121. The solar module 110, when it is not in energy production mode, also can serve as a radiation cooler for the flow of fresh air 111 to pass a cooling power into the home.

In a specific embodiment, the control module 140 is configured to control the operation of the solar energy system on both solar energy production and utilization. As shown in FIG. 1, the control module 140 couples with the energy transfer module 120 via a connection 142. The control module 140 uses selected control information to operate a plurality of control elements associated with the energy transfer module 120 for receiving the flow of fresh air and processing the flow of fresh air. In one embodiment, the flow of fresh air is passing through a heat exchanger 124 to partially transfer the thermal energy carried by the flow for meeting requirement of one or more thermal loads associated with the home dwelling 101. For example, one thermal load is for water heating.

Further, the control module 140 controls a blower 125 in the energy transfer module 120 to adjust the flow rate and controls one or more dampers 127, 128 to guide the flow out to different destination through corresponding air outlets 122, 123, respectively. Depending on operation mode of the solar energy system 100 being set at heating/cooling or fan mode by the control module 140, the flow of fresh air 129 is delivered to an interior space 106 of the home or be exhausted back to outside ambient. The energy transfer module 120 also includes multiple sensors 171, 172 disposed at both upstream and downstream regions around the blower 125. Information associated with the flow temperature, pressure, flow rate, and flow volume per certain time period can be determined and sent to the control module 140 whenever the blower 125 is in operation and one damper 127 or 128 is open. When the solar energy system 100 is in heating mode and actively runs to generate thermal energy, the flow of the fresh air 111 in the plenum structure 115 will be heated therein and can be delivered to the home via the outlet 123 for providing both space heating and ventilation. When the solar energy system 100 is set at a cooling mode, during the active period the flow of the fresh air 111 can be exhausted via the outlet 122 instead of being delivered into the home. While after the active period ends (most likely in the night time) the flow of the fresh air 111 is cooled by the solar module 110 via a radiation cooling effect and can be delivered into the home again via the outlet 123 for providing space cooling and ventilation. In multiple aspects of the system application, the flow of the fresh air 111 can be processed in the energy transfer module 120 under the control of the control module 140 and be utilized at least partially to provide space heating, space cooling, as well as home ventilation for interior space 106 of the home 101. Of course, there are many variations, alternatives, and modifications. For example, the energy transfer module 120 also includes a heat exchanger 124 for partially transfer the thermal energy carried by the flow of fresh air for water heating and other applications through one or more auxiliary thermal systems.

In another specific embodiment, as shown in FIG. 1, the thermostat device 150 is disposed in an interior space 106 of the home 101 to couple with an HVAC system 180 via a connection 158. In particular, the HVAC system 180 includes a traditional air handler associated with an air conditioning module and a furnace module for transferring a conditioned airflow 189 to the home dwelling depends on a heating/cooling mode set for the HVAC system. The HVAC system 180 is coupled to the energy transfer module 120 so that the delivery of the conditioned airflow 189 can be coordinated with the flow of fresh air delivered from the energy transfer module utilizing at least partially the thermal energy produced by the solar energy system 100. The control system 1000 uses the thermostat device 150 to control, based on loaded modes of operation, one or more control elements (for example, a damper 188 and more) to operate the HVAC system 180 for receiving a return airflow 187 via an air inlet 181 from the interior space 106 and delivering the conditioned airflow 189 through an outlet 182. In an embodiment, the integration of the solar energy system 100 with the HVAC system 180 allows the outlet 182 to couple with the outlet 123. The conditioned airflow 189 generated by the HVAC system 180 can be optionally mixed with the flow of fresh air 129 delivered via the outlet 123 from the energy transfer module 120 before finally being delivered to the interior space 106 for providing space conditioning and home ventilation. Accordingly the control system 1000 uses control module 140 to replicate a control of the solar energy system 100 in coordination with the operation of the HVAC system 180 by the thermostat device 150 to achieve an optimization on solar energy utilization in a process for providing space conditioning and home ventilation. More details about the coordinated control operation can be found throughout the specification and particularly below.

As shown in FIG. 1, the thermostat device 150 includes at least a temperature sensor 155, a touch-screen display 156, a first external port for connection 158 and a second external port for plugging a communication device 151 which is used for wirelessly connecting with the control module 140. The temperature sensor 155 is able to measure local interior space temperature and the touch-screen display 156 allows user to enable pre-programmed automatic operation settings or manually input (fixed) mode settings. In an embodiment, the communication device 151 is a Zigbee U-snap module configured to send short distance radio signal for establishing a local wireless network. The control module 140 correspondingly includes a USB port for inserting a Zigbee USB stick 141. The Zigbee USB stick is configured to mate with the Zigbee U-snap module 151 and form a Zigbee wireless network dedicated for both of them, i.e., the connection 145 in FIG. 1, but closing for any other wireless devices.

In an embodiment, the control system 1000 is configured to operate the thermostat device 150 at a simple mode capable of transmitting updated information about the local interior space condition and the modes of operation set for the thermostat device 150 to the control module 140 via the Zigbee wireless network 145. Alternatively, the control system 1000 also is configured to allow a user or home owner to input or update control settings through the graphic user interface 200 linked to the control module 140. The control system 1000 further lets the control module 140 to use the dedicated Zigbee wireless network 145 to transmit these control settings to the thermostat device 150 so that the modes of operation of the thermostat device 150 for controlling the HVAC system 180 can be defined or updated. Of course, there can be other variations, alternatives, and modifications. For example, the thermostat device 150 includes not just a single temperature setpoint for either operating the HVAC system in a heating mode or a cooling mode, instead, it includes different sets of setpoints for automatic operation (either in a heating or cooling mode) based on three types occupancy states including home, sleep, and away. Each heating or cooling setpoint is adjustable independently for each type of occupancy state.

In an alternative embodiment, the control system 1000 is configured to operate the energy transfer module of the solar energy system in a coordinated process with the operation of the HVAC system for providing space conditioning and ventilation with substantial energy saving. The coordinated process includes at least 1) from the graphic user interface defining control information including associating a comfort band setting with the control system 1000 to operate the solar energy system 100 in either a heating mode or a cooling mode and setting modes of operation for the thermostat device 150 to operate the HVAC system 180 in either a heating mode or a cooling mode; 2) communicating the control information between the control module and the graphic user interface; 3) communicating the control information and local space condition information between the control module and the thermostat device; 4) initiating operation the solar energy system based on the comfort band setting before initiating operation of the HVAC system based on a temperature setpoint for either the heating mode or cooling mode. The coordinated process is to ensure that at least there is no conflict between the solar energy system heating/cooling mode versus the HVAC system heating/cooling mode. In a specific embodiment, the comfort band setting is defined by a temperature range between T_comfort_min and T_comfort_max that is adjustable to ensure comfort felt by people in the target space within the home dwelling and to promote energy saving if people do not occupy the target space or are in a sleep state.

For example, in a heating mode, parameter T_comfort_max is a setpoint for initiating the solar energy system to deliver a flow of fresh air carrying thermal energy to the target space of the home dwelling. Parameter T_comfort_min is just set as the temperature setpoint set for the thermostat device in heating mode, i.e., a HVAC heating setpoint, for initiating HVAC system to provide a heated airflow. The HVAC heating setpoint is set to a lower value than a setpoint for conventional HVAC system so that the HVAC operation in embodiments of the current invention is intentionally delayed while the solar energy system is used for providing required space heating via solar thermal energy utilization. Only when the HVAC heating setpoint is triggered at the lower value, should the HVAC system be initiated to provide a heated airflow (via furnace heater) for meeting the space heating requirement. Therefore, the energy use for providing spacing heating/ventilation is greatly reduced.

In a cooling mode, parameter T_comfort_min is a setpoint for initiaing the solar energy system to deliver a flow of fresh air cooled by the solar module disposed in an outdoor region of the home dwelling. Parameter T_comfort_max now is just set as the temperature setpoint for the thermostat in cooling mode, i.e., a HVAC cooling setpoint, for initiating HVAC system to provide a cooled airflow. In an embodiment, the HVAC cooling setpoint is set to a higher value than a setpoint for conventional HVAC system so that the HVAC operation in embodiments of the current invention is intentionally delayed while the solar energy system is used for providing required space cooling. Only when the HVAC heating setpoint is triggered at the higher value, should the HVAC system be initiated to provide a cooled airflow (via air conditioner) for meeting the space cooling requirement. Therefore, the energy use for providing spacing cooling/ventilation is also greatly reduced.

In another specific embodiment, these control settings are all able to be inputted, adjusted, and updated by using a remotely accessed graphic user interface via the link to the control module through a network hub and through a wireless network between the control module and the thermostat device. More information about the graphic user interface of the control system 1000 for providing optimized space conditioning and home ventilation can be found throughout the specification and particularly below.

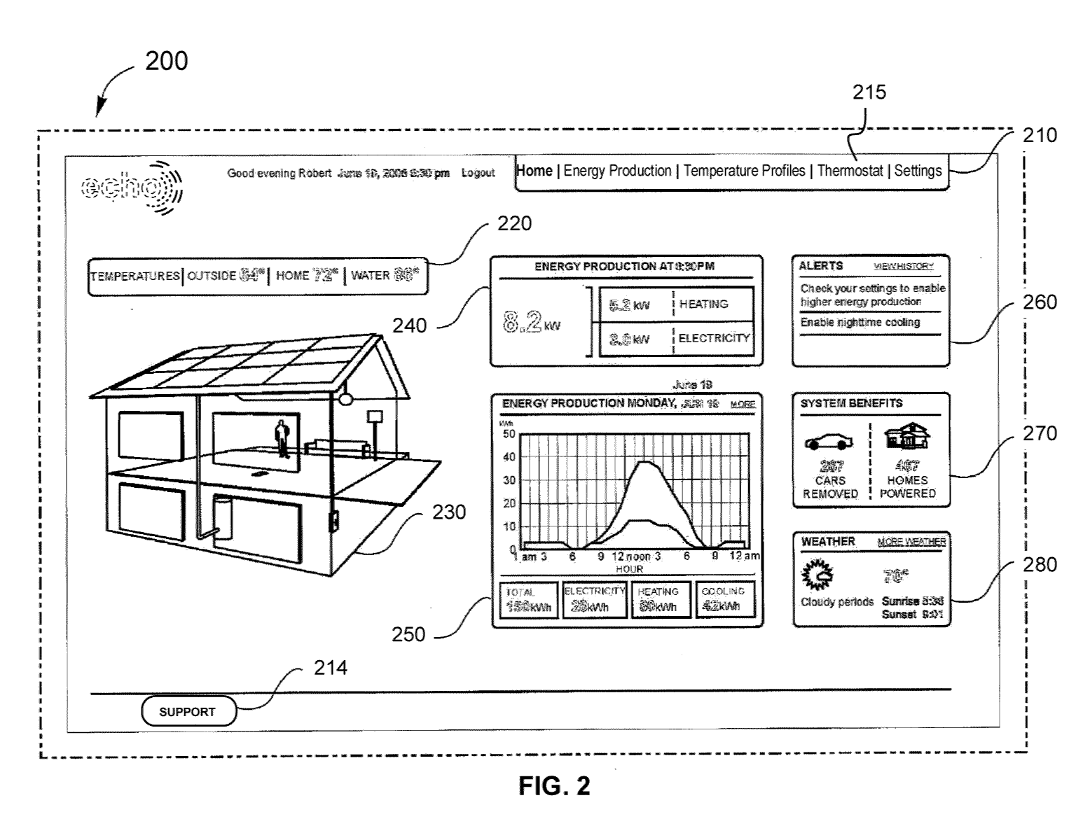

FIG. 2 is a display view of a graphic user interface home page for controlling a solar energy system coupled with a HVAC system according to an embodiment of the present invention. This diagram is merely an example, which should not unduly limit the scope of the claims herein. One of ordinary skill in the art would recognize other variations, modifications, and alternatives. As shown, the graphic user interface 200 is configured for monitoring and controlling the solar energy system (e.g. system 100) and the integrated HVAC system (e.g., auxiliary system 180). In a specific embodiment, the graphic user interface 200 includes a home page having a variety of graphical features such as a tool bar 210 that includes at least prompts directed to Energy Production, Temperature Profiles, Thermostat (215), and Settings in addition to a current Home prompt (as shown in FIG. 2). The graphic user interface 200 also includes additional feature displays or control functions directing to a user greeting message, a date-and-time display, and Auto-Refresh, Logoff button, & Support prompts (214).

Additionally, the Home page of the interface 200 includes a number of functional elements: a temperature display panel 220, a graphical illustration 230 of a solar array coupled to a building structure, a current energy production display panel 240, an cumulative energy production history diagram display panel 250, an alerts/notifications display panel 260, a system benefits display panel 270, and a weather display panel 280. As shown, each of the functional elements described herein can include a navigation function that can be accessed by way of a mouse cursor positioned over a respective icon or link which allows entry. Of course, there can be other variations, modifications, and alternatives.

The present invention allows for easy accessing, monitoring, and performing controlling the operation of a solar energy system implemented at a target home (e.g., the home 101). Once a user has initialized a computing device to launch the graphic user interface 200, the user can immediately determine the status of the operation of an integrated home energy system including a solar energy system coupled with other auxiliary thermal systems (including the HVAC system) for the target home. Sometime the integrated home energy system is called a healthy home system. The temperature display panel 220 allows the user to determine indoor, outdoor, and water heater temperature easily and clearly. The graphical illustration 230 of the solar modules coupled to the user's target home allows the user to quickly determine the operative status of the healthy home system including operation of solar panel (both PV and thermal panel), electric inverter, indoor heating, and water heating systems. In an embodiment, working status of these systems is clearly displayed by use of color-coded animations to indicate whether a particular system is functional or requires attention. The use of easily recognizable animations and clear display of subsequent temperatures maintained in the healthy home system provides ease accessibility to virtually every ordinary user. In an embodiment, all information as displayed in the graphic user interface 200 is updated within a predetermined time period, for example, every 15 minutes and less. One skilled in the art would recognize other variations, modifications, and alternatives.

The current energy production display panel 240 and the cumulative energy production history diagram display panel 250 provides the user with general information related to thermal and electrical energy production of the solar energy system. In a specific embodiment, the energy production rate display panel 240 includes information about the total energy production rate, the current electrical, and the thermal energy production rate. The current production display panel 1440 can also display the current time at which the rate of energy production is measured. In a specific embodiment, the history diagram display panel 250 includes information about the total cumulative production energy, and individual totals for energy production for electrical, heating, cooling, and ventilation applications. The display panel 250 also includes a diagram of past total energy production over a specified time span. The diagram of past total energy production over time allows the user to easily determine peak hours and off hours for his/her healthy home system. Also, the information related to cumulative energy production allows the user to readily determine and compare absolute values of energy produced for different thermal/electrical utility applications within the healthy home system. Again, there can be many other variations, modifications, and alternatives.

The alerts/notifications display panel 240, the system benefits panel 270, and the weather display panel 280 provide the user with additional useful information about the healthy home system or information useful for comparison to the healthy home system output. In a specific embodiment, the alerts/notifications display panel 260 can include notices about routine checks or warnings regarding the operation of the healthy home, and the like. Also, the alert display panel 260 can include additional navigational features that are accessed by way of a mouse cursor positioned over a respective icon or link which allows to user to access additional windows within the graphic user interface 200 to control the operation of the healthy home system. In an embodiment, the system benefits panel 270 provides information about local and/or global benefits about the user's current healthy home system or the cumulative benefits of a community, specified region, and the like. The benefits panel 270 provides the user with information about the contributions he/she is making through the use of their healthy home system. In a specific embodiment, the weather display panel 280 provides the user with local weather forecast information for convenience. These display panels provide additional information and functions, but are not limited to the functions described herein, for the user's convenience.

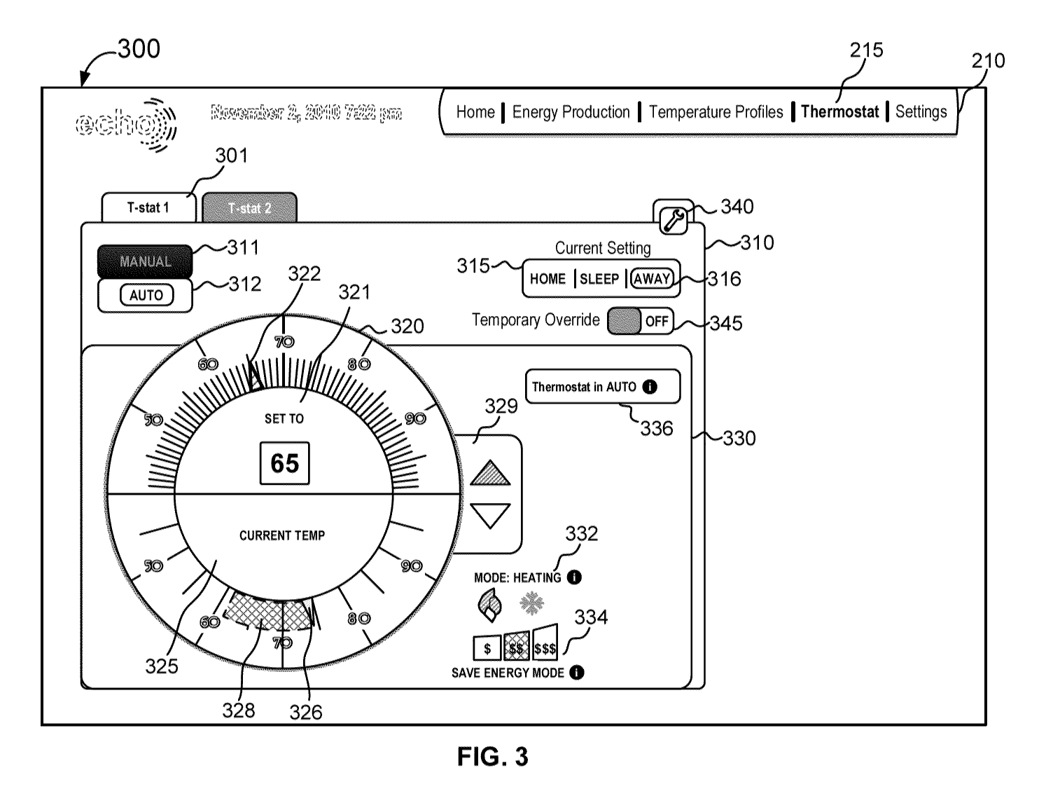

From the tool bar 210, a click of Thermostat prompt 215 leads to a new interface page displaying a virtual thermostat control/setting features. FIG. 3 is a display view of a virtual thermostat page from the graphic user interface home page in FIG. 2 according to the embodiment of the present invention. This diagram is merely an example, which should not unduly limit the scope of the claims herein. One of ordinary skill in the art would recognize other variations, modifications, and alternatives. As shown, the virtual thermostat page 300 includes a thermostat functional display panel 310, which can be associated with a specifically thermostat device (e.g, a down-stair thermostat) by clicking a tag 301 (e.g., T-stat 1) or clicking one of neighboring tags (e.g., T-stat 2) to switch to another field-installed thermostat (e.g., an up-stair thermostat). The thermostat device is coupled to a HVAC system and uses the control settings associated with its modes of operation to operate the HVAC system for providing a conditioned airfow to the corresponding space region where the thermostat device is disposed. The thermostat functional display panel 310 includes multiple control buttons 311, 312, 315, a temperature setting display 320 having a Honeywell-Dial look, a mode setting display 330, and an advanced setting button 340 (plus an associated function switch button 345). The control buttons 311 and 312 directly provide a switch function to choose either an Auto mode or a Manual mode. The Auto mode (as shown in FIG. 3) includes at least three modes of operation with control settings for three types of occupancy states including 1) Home, 2) Sleep, and 3) Away. The control button 315 further provides a switch function for illustrating a current mode (e.g. for away status 316) of operation and switching to an alternate mode of operation. Each mode of operation is associated with a set of control settings including different temperature setpoints for heating, cooling, or relevant comfort band setting. The Manual mode (not explicitly display here) allows user to enforce a particular fixed setting to operate the HVAC system.

In a specific embodiment, the temperature setting display 320 has a round dial format providing users an intuitive GUI. The round dial display includes an upper-half dial display 321 for temperature setpoint adjustment associated with an HVAC system for controlling space heating/cooling. The temperature setpoint is both displayed as a digital numerical and illustrated by an arrow pointer 322 movable along the dial scale using a mouse cursor, and adjusted by using mouse cursor to drag the pointer 322 or clicking up-pointed triangular button 329 on the right side of the round dial display. For example, the Setpoint, e.g., 65 (° C.), is displayed as a digital reading in the middle square. The round dial display also includes a lower-half dial display 325 for showing a current temperature 326 and a comfort band 328 set for the healthy home system to initiate operation of the solar energy system. In the mode setting display 330 there is a mode display 332 for showing what the current mode (heating or cooling) of operation for the HVAC system is. A number of set buttons 334 for adjusting the range of the comfort band under a so-called save energy mode. A single $-sign button means a smaller range is assigned to the comfort band and a triple $-sign button means a wider range is assigned to the comfort band. Depending on whether the system is in heating mode or cooling mode, the comfort band adjustment corresponds to the adjustment of either the lower end value T_comfort_min for cooling or the upper end value T_comfort_max for heating. For example, the comfort band setting 328 in a heating season is shown to be between 62-74° C. for minimizing energy usage in the Away state. In a specific embodiment, the control settings mentioned above can be color coded for correlated features and animated for certain dynamically updating feature. For example, the comfort band 328 is colored green and the particular button (e.g., the middle one) 334 in the save energy mode chosen for setting the comfort band is also high-lighted in green. The arrow display 326 for illustrating current temperature may be automatically rotated to pointed to a temperature mark corresponding to the current home temperature. Another button 336 is for displaying a current mode of operation of the thermostat in Auto mode. Extra information regarding the system operation and functionality is also available for user/customer by clicking a small info icon within this button 336.

In another specific embodiment, the advanced setting button 340 provides additional control setting in a new control page for the thermostat device in the Auto mode of operation. In current display page, the advance setting button 340 is hided in a small icon attached to the thermostat functional display panel 310 associated with the virtual thermostat page 300. An On-Off switch button 345 is displayed within the functional display panel 310 and used to turn on/off a temporary override function related to the advanced setting. Further details of the virtual thermostat advanced setting function, including a calendar schedule setting and the temporary override ending-schedule setting, can be found in following portion of the specification and more particularly in the paragraph below.

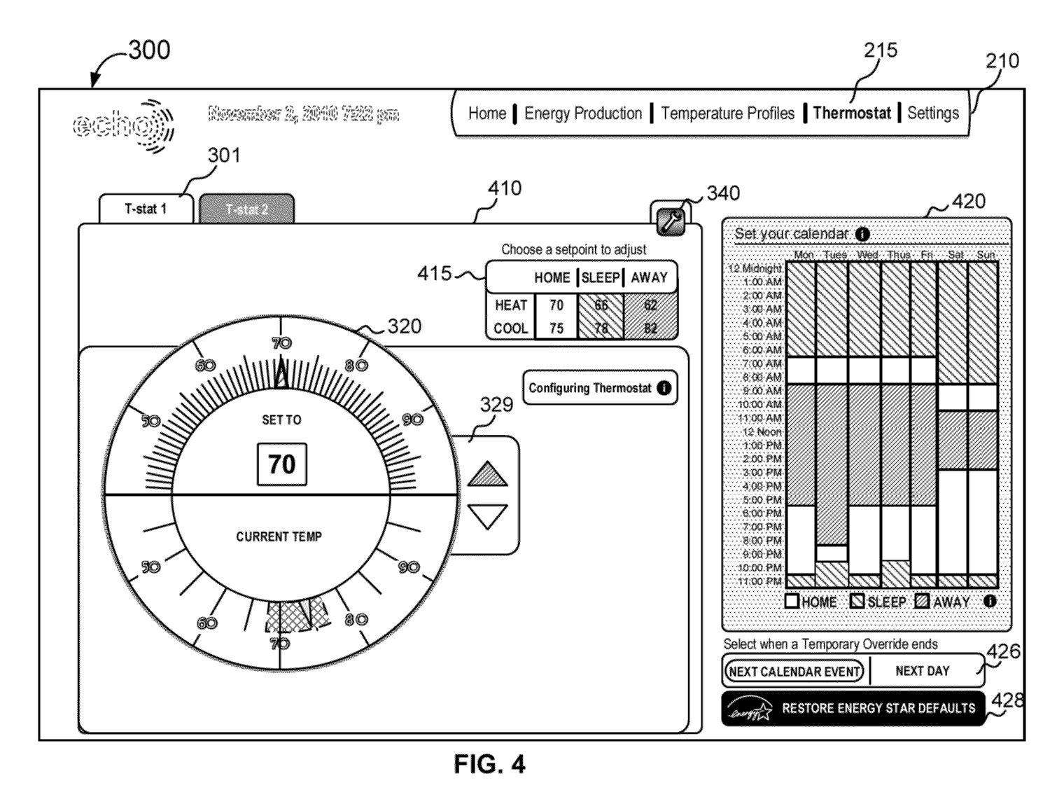

FIG. 4 is a display view of an advanced calendar setting window from the virtual thermostat page in FIG. 3 according to the embodiment of the present invention. This diagram is merely an example, which should not unduly limit the scope of the claims herein. One of ordinary skill in the art would recognize other variations, modifications, and alternatives. As shown, by clicking the advanced setting button 340, a virtual thermostat advanced setting page 400 is illustrated, including a thermostat setpoint display 410, a block grid diagram 420 for 7-day 24-hour home occupancy hourly schedule setting, and a selection button 426 for temporary override setting and a set button 428 for default setting restore. The thermostat setpoint display 410 retains substantially the round dial appearance having an upper half for temperature setpoint display and a lower half for comfort band and current home temperature display. The thermostat setpoint display 410 also is associated with the tag 301 for corresponding thermostat T-stat 1 (for example, a thermostat disposed in a down-stair space of the home) and can be switched to another thermostat setpoint display by clicking a neighboring tag. In the setpont display 410, a set button 415 is expanded from the button 315 with three sections respectively representing three auto modes of operation for three occupancy states: Home, Sleep, and Away. Each auto mode of operation is associated with a HVAC heating setpoint and a HVAC cooling setpoint. By choosing any one mode of operation (in Auto mode of the thermostat device), both the heating setpoint and the cooling setpoint can be adjusted and the thermostat device is thus re-configured.

In a specific embodiment, the virtual thermostat advanced setting page 400 includes a block grid diagram 420 next to the thermostat setpoint display 410. The block grid diagram 420 is a color coded hourly-based scheduler configured to assign an occupancy state to each one-hour time period in a full 24-hour day for a whole week. For example, a yellow color represents Home state, a blue color represents Sleep state, and orange color represents Away state. In a specific embodiment, a drag-and-drop approach is applied to insert color-coded home occupancy status characteristics to corresponding calendar space bars with 24-hour range per day. For each day up to four schedule periods are allowed. For example, a first period starts from 11:00PM of a particular day to 6:00AM (the next day) with a Sleep status assigned. A second period starts from 6:00AM to 8:00AM in a Home status. Then a third period starts from 8:00AM to 6:00PM with an Away status followed by a fourth period with another Home status assigned from 6:00PM to 11:00PM. For a different day, the schedule setting can be the same or partially the same or completely different with total number of periods equal to four or less. After setting is finished, the corresponding calendar schedule is automatically saved for the virtual thermostat (e.g., corresponding to a particular field thermostat T-stat 1). Additionally, there is a selection button 426 to define when a temporary override operation ends with options of ending in next calendar event and in next day. This temporary override feature is activated in the virtual thermostat page 300 by using the switch button 345 (see FIG. 3). Further, a setting button 428 is clicked to restore Energy Star Default setting for the system. Of course, there can be other variations, alternatives, and modifications.

It is also understood that the examples and embodiments described herein are for illustrative purposes only and that various modifications or changes in light thereof will be suggested to persons skilled in the art and are to be included within the spirit and purview of this application and scope of the appended claims. Further details of a method for remotely controlling a thermostat for operating a healthy home solar energy system can be found throughout the present specification and more particularly below.

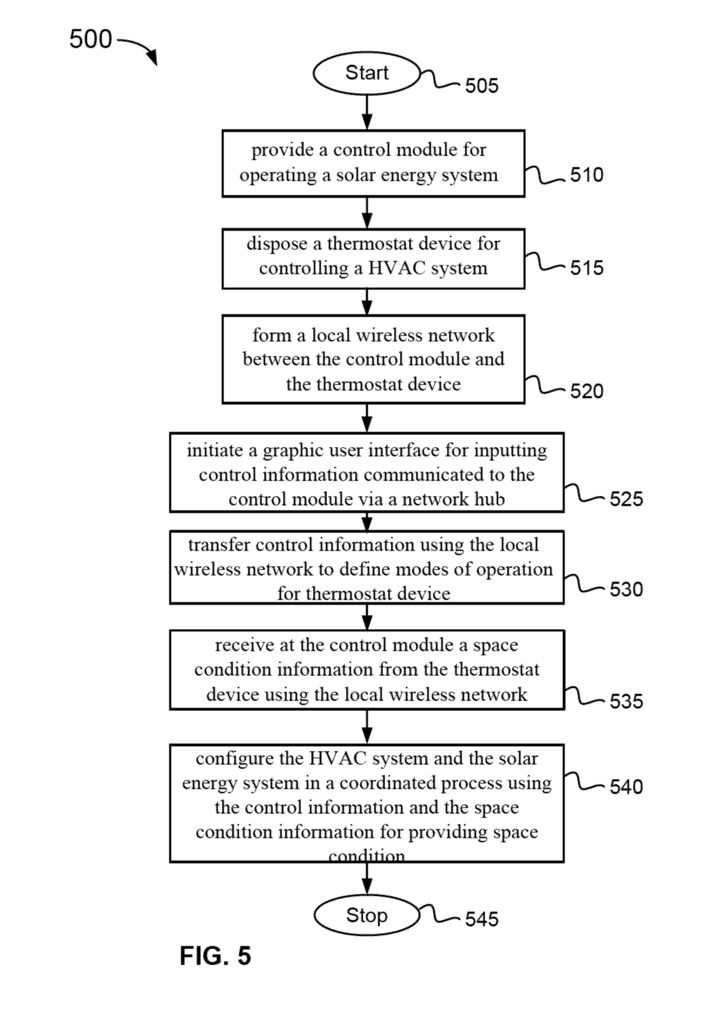

FIG. 5 is a simplified flow diagram illustrating a method of controlling an operation of a solar energy system in coordination of an operation of a HVAC system for providing ventilation and space conditioning according to an embodiment of the present invention. This diagram is merely an example, which should not unduly limit the scope of the claims herein. One of ordinary skill in the art would recognize many other variations, modifications, and alternatives. It is also understood that the examples and embodiments described herein are for illustrative purposes only and that various modifications or changes in light thereof will be suggested to persons skilled in the art and are to be included within the spirit and purview of this process and scope of the appended claims.

As shown in FIG. 5, the present method 500 can be briefly outlined below.

1. Start;

2. Provide a control module for operating a solar energy system of a home;

3. Dispose a thermostat device for controlling a HVAC system in the home;

4. Form a local wireless network between the control module and the thermostat device;

5. Initiate a graphic user interface for inputting control information communicated to the control module via a network hub;

6. Transfer control information using the local wireless network to define modes of operation for thermostat device;

7. Receive at the control module space condition information from the thermostat device using the local wireless network;

8. Configure the HVAC system and the solar energy system in a coordinated process using the control information and the space condition information for providing space conditioning; and

9. Stop.

These steps are merely examples and should not unduly limit the scope of the claims herein. As shown, the above method provides a way of providing optimized control in space conditioning and home ventilation within a healthy home system according to an embodiment of the present invention. In a preferred embodiment, the method uses a control module configured to establish a dedicated wireless communication with a thermostat device installed in a home space and using a graphic user interface linked to the control module for executing remote control of the thermostat device for operating a HVAC system in a coordinates process with the operation of a solar energy system to provide energy saving in space conditioning and home ventilation. One of ordinary skill in the art would recognize many other variations, modifications, and alternatives. For example, various steps outlined above may be added, removed, modified, rearranged, repeated, and/or overlapped, as contemplated within the scope of the invention.

As shown in FIG. 5, the method 500 begins at start, step 505. The present method provides a method for providing a coordinated operation of a solar energy system and an HVAC system optimized for substantial energy saving in space conditioning and home ventilation. An advanced control system, including network communication features, remotely accessed graphic user interface, dedicated wireless network, and smart thermostat device and solar energy system control module, is implemented in a healthy home energy system for achieving efficient solar thermal energy utilization and energy use reduction. Here, the method begins with an application on the healthy home energy system implemented at a target home building structure with solar-energy-based multiple utility applications, such as electrical generation, water heating, space heating/cooling, and home ventilation, as well as others.

The healthy home energy system, in a specific embodiment, is a home-based solar energy system (e.g., system 100 in FIG. 1) coupled/integrated with one or more traditional auxiliary thermal systems and operated in a coordinated process by a control module and one or more thermostat devices for utilizing solar energy efficiently for home utility applications. The method 500 includes, step 510, providing a control module (e.g., control module 140 in FIG. 1) for controlling the operation of the solar energy system. In a specific embodiment, the solar energy system includes a solar thermal module for collecting a flow of fresh air from ambient. The flow of fresh air is used as a thermal medium to carry solar thermal energy generated by the solar thermal module converted from the solar energy source. In another specific embodiment, the solar energy system also includes an energy transfer module coupled to the solar thermal module to receive the flow of fresh air guided (see FIG. 1) through a plenum structure from the solar thermal module. The energy transfer module is configured to process the received flow of fresh air to utilize the thermal energy at least partially for one or more home utility applications. For example, a heat exchanger (see FIG. 1) is used to transfer partially the carried thermal energy for water heating to supply hot water for the home building structure (or a heated pool). In another example, the flow of fresh air can also be delivered to internal home space for space heating in a controlled way using a motorized blower and a powered damper along the path. In yet another example, the flow of fresh air can be used as a cooling medium when the solar thermal module serves as a radiation cooler during its inactive period (e.g., at night) and be delivered to the internal home space for space cooling. The control module associated with the solar energy system is configured to couple with a plurality of control elements, including the blower, dampers in multiple air outlets, and various sensing devices, for adjusting, processing, and monitoring the flow of fresh air to utilize the solar energy and save energy usage for the home. Of course, there can be other variations, modifications, and alternatives.

The healthy home energy system, in the embodiment, also is integrated with one or more auxiliary thermal systems operated in a coordinated process with the solar energy system. The method 500, in next step 515 according to an embodiment of the present invention, includes disposing a thermostat device in a home space for monitoring interior space condition and providing control of an HVAC system. The thermostat device is configured to couple with one or more control elements of the HVAC system (see FIG. 1) coupled with the solar energy system. Based on one or more control settings programmed in the thermostat device the HVAC system is operated for generating a conditioned airflow for space conditioning and home ventilation. The integration of the HVAC system with the solar energy system allows the conditioned airflow at least partially coupling with the flow of fresh air delivered from the energy transfer module so that the thermal energy carried by the flow of fresh air is utilized. The delivery of the conditioned airflow and the flow of fresh air can be coordinated so that the energy usage for generating conditioned airflow is minimized for saving.

In certain embodiments, the target home have multiple spatial zones such as bedroom, living room, up-stair space, or down-stair space, and others, correspondingly multiple thermostat devices can be disposed respectively in the multiple spatial zones. Each of these thermostat devices includes one or more temperature sensors, a connection port for coupling with the HVAC system. The thermostat device further includes a wireless communication device inserted in one port capable of transmitting/receiving digital signals via an established wireless network. Additionally, the thermostat device includes a touch-screen display allowing user or field engineer to input control settings and make necessary adjustment of one or more temperature setpoints, modes of operation, weekly/daily occupancy scheduling, and the like. The thermostat device further includes multiple modes of operation capable for programming or setting control information for the HVAC system, reporting local space conditions, and performing signal receiving and transmitting, and performing other I/O functions. Of course, there can be many variations, alternatives, and modifications.

In a specific embodiment, the method 500 includes a step 520 of forming a local wireless network between the control module and the thermostat device (or each of the multiple thermostat devices) disposed in the interior regions of the home structure. In particularly, the method includes a commissioning process for establishing a point-to-point local wireless network between the control module and the thermostat device in the healthy home energy system. The process starts with a step to power down both the control module and the thermostat device in order to initialize network mating between them. The process is then followed by a step to insert a Zigbee U-snap module into the communication port of the thermostat device. The thermostat device has been pre-configured to have at least a mode of operation for initiating a wireless communication with other device (see FIG. 1). The process further includes a step of inserting a battery (a default power) into the thermostat device. Also a Zigbee USB stick is inserted into a USB port of a CPU board of the control module (see FIG. 1). The USB port is configured to be populated by the Zigbee radio required by the installation for transferring data and software updates to & from the control module in instances when the network does not exist or the control module has lost communication capability. Furthermore, the process includes a step of powering up the control module for initiating network mating between the Zigbee USB stick in the control module and the Zigbee U-snap module in the thermostat device to form a Zigbee network between them. In this step an identification command can be sent from the Zigbee U-snap module to the USB stick using a Transterm protocol. The control module then can recognize the identified thermostat, then an echo signal may be answered back to the Zigbee module in thermostat device.

Additionally, the commissioning process includes a step of validating the Zigbee wireless network. This step may include sending/receiving test data with predetermined information bytes and security codes between the two Zigbee devices. The data transfer rate, signal strength, and stability needs to be validated based on a predetermined standard. The process further includes a step of closing the network, which means to make the established Zigbee wireless network a point-to-point network exclusively to the as-mentioned two devices: the control module and the thermostat device. No rogue wireless devices can be allowed to enter and deform the local wireless network.

Referring to FIG. 5, the method 500 further includes a step, 525, for initiating a graphic user interface for inputting control information communicated to the control module via a network hub. In one or more embodiments, the graphic user interface is loaded and initialized on any computing device or system that supports the user interface program displaying the graphical contents and functional setting buttons. The graphic user interface accepts user's inputs through an input device, such as a mouse, keyboard, touch screen, scanner, digital camera on smart phone or flat-panel device iPad or netbook, and the like. The graphic user interface is initialized, in one embodiment, through a user sign-up process, a user validating process, and a login process. The user then establishes a link between the computing device running the graphic user interface and a data server in a network hub. The control module is connected and communicated with the data server through an Ethernet or a world wide network of computers, i.e., the Internet. Therefore, the graphic user interface is correspondingly linked with the control module for controlling the solar energy system associated with the target building structure that is designated for the particular user. The graphic user interface, in an embodiment, is used to input control information and store into the data server, from which the control module can update the control information within a predetermined time period, e.g., every 15 minutes and less.

In another specific embodiment, the method 500 provides a step 530 of transferring control information using the local wireless network to define modes of operation for thermostat device. This step includes enabling the thermostat device from the graphic user interface associated with the control module using the established Zigbee local wireless network. In particular, the enabling process is performed under a virtual thermostat page within the graphic user interface specifically designated for programming control settings for each identified thermostat device. Within the virtual thermostat page, a high-lighted tag automatically enables a particular thermostat device. By clicking a neighboring tag, another thermostat device can be then enabled to allow corresponding control settings to be programmed or manually updated. As seen in FIG. 2, the virtual thermostat page includes at least following features: a temperature setting panel based on a “Honeywell Dial” thermostat layout, temperature setpoint control, seamless control for operating an HVAC system with multiple automatic (and manual) modes of operation. It is also configured to define a comfort band setting associated with a setpoint to initiate operation of the solar energy system before initiating the operation of HVAC system to reduce system energy usage in space conditioning and ventilation. Furthermore, the virtual thermostat page also includes a schedule calendar for occupancy setting for a 24/7 time period and three types of occupancy states.

Once the local wireless network is validated and closing, the control module and the thermostat device can share information back and forth within a predetermined time period, for example, every 20 seconds. The control settings inputted or activated through the virtual thermostat in the graphic user interface are transformed into one or more data packets that are sent to the Zigbee wireless device inserted in the thermostat device and may be updated every 20 seconds. The thermostat device disposed in the interior home region is configured to process the data packets and update the control settings therein. For example, when an Auto mode program with an occupancy state being set to Home is assigned, a particular HVAC heating/cooling setpoint is selected, and a comfort band with corresponding T_comfort_min and Tcomfort_max is selected in the virtual thermostat, the enabled thermostat device in the field then is set to the Auto (heating or cooling) mode with the assigned occupancy state and selected comfort band. The thermostat device is thus ready for using the selected control information to operate the designated HVAC system. For example, in an Auto cooling mode the thermostat device is coupled to one or more control elements of an air conditioner system integrated with the solar energy system for generating a conditioned airflow for space cooling and home ventilation if the HVAC cooling setpoint is triggered. Of course, one skilled in the art would recognize many other variations, modifications, and alternatives.

According to one or more embodiments of the present invention, the method 500 conversly provides a step, 535, for receiving at the control module a space condition information from the thermostat device using the local wireless network. Followed the step 530, the thermostat device may operate the HVAC system in an Off mode if the temperature falls within the selected comfort band and at the same time the thermostat device uses the local wireless network to transfer the local space condition information (e.g., interior temperature) and the control information to the control module. The control module is configured to initiate the energy transfer module using the space condition information and control information to deliver a flow of fresh air collected from ambient for keeping the interior home region within the comfort band without initiating operation of the HVAC system. One particular local space condition information is an interior temperature measured by a temperature sensor built in the thermostat device. A current reading of the interior temperature is sent as part of the digital packet transmitted via the wireless device of the thermostat device to the control module. Again, as mentioned above, the communicaiton from the thermostat to the control module can also be executed every 20 seconds or within another pre-determined time span. These information is also updated to the data server and sychronized with the graphic user interface within 15 minutes and less, allowing a user to remotely access, monitor, compare, and perform further control operation using the information shown in the graphic user interface.

Furthermore, the method 500 provides a step 540 for configuring the HVAC system and the solar energy system in a coordinated process using the control information and the space condition information for providing space conditioning. In an embodiment, the coordinated process includes a first step for communicating the selected control information between the control module and the graphical user interface via the network hub. The communication process is executed by updating and maintaining the same control information at the graphical user interface, the control module, and the data server if the selected control information has been changed based on the space condition information received at the control module or control information inputted at the graphical user interface. The control module uses the control information and particularly the comfort band setting to initiate operation of solar energy system including particularly the energy transfer module to provide space conditioning and ventilation if the interior temperature is within the selected comfort band. The coordinated process further includes a second step for updating the control information from the control module to the thermostat device using the wireless network. The thermostat device uses the updated mode of operation together with the current interior space information to operate the HVAC system whenever the local space condition is met and only when the interior temperature is out of the range of the selected comfort band.

The graphic user interface allows a temporary overide switch to be turned on, then the control setting can be overided temporarily and automatically ended at a predetermined ending schedule. For example, a calendar schedule function allows user to set up a weekly occupancy status/event schedule up to 4-periods per day. In case a change needed for a particular calendar event or calendar day, the new (or temporary) setting can be adjusted and sent as a data packet to the control module. The modes of operation of the thermostat device can be either automatically reset following certain predetermined schedules or pre-set occupancy states or temporarily override by a manual input.

The user or home owner still has option to input or update the control setting program from the touch screen of the thermostat disposed in the home. In another example, the HVAC heating/cooling setpoints can be digitally re-adjusted so that the modes of operation of the thermostat can be changed from a heating mode to a cooling mode when comparing the current interior temperature with different setpoints. These information can be communicated to the control module and utilized to replicate control settings for the solar energy system. For example, when the thermostat is set as heating mode and the interior temperature is shown to be below the HVAC heating setpoint, the control module may update the setting of the solar energy system to either enable an active period to generate solar thermal energy and to deliver a flow of fresh air carrying the thermal energy into the home for providing space heating as needed. Alternatively, the control module may initiate operation of the energy transfer module to shut down a damper in the airduct to cut off the flow of fresh air during the off period of the solar energy system so that no cool ambient air is directed into the home that needs heating. Conversely, in cooling season, the control module can replicate control settings of the thermostat device to properly operate the solar energy system for delivering a flow of fresh air at reduced temerature to assist the space cooling and reduce regular energy usage of an HVAC system for providing conditioned airflow.

In another embodiment, the control module also replicates the control settings of the solar energy system for delivering a flow of fresh air for ventilation with a timing that is coordinated with operation for providing space heating or space cooling. Therefore, the home ventilation via the flow of fresh air collected by the solar energy system can be controlled to assist space heating or space cooling without increasing thermal load. The coordinated control of the healthy home energy system via the communication between the control module and the thermostat device according to the embodiments of the present invention provides substantial enhancement in an effective efficiency of solar energy utilization and reduction in energy usage and conservation of energy resources. Of course, there can be other variations, alternatives, and modifications.

The above sequence of processes can be stopped at step 545. The method 500 provides a healthy home energy system having a coordinated control of a solar energy system and a HVAC system on applications of space conditioning and home ventilation according to an embodiment of the present invention. As shown, the method uses a combination of steps including using a web-based graphic user interface to remotely execute control settings via a control module for operating the solar energy system and a wirelessly inked thermostat device for operating an HVAC system. The control module can be substantially free from direct coupling with the HVAC system. Alternatively, the method as mentioned above can be implemented in the control system 1000 described in FIG. 1. Other alternatives can also be provided where steps are added, one or more steps are removed, or one or more steps are provided in a different sequence without departing from the scope of the claims herein.

The embodiments and all examples mentioned above provide a method and control system for providing coordinated control over the operations of a solar energy system coupled with an HVAC system for efficiently utilizing solar energy and reducing energy usage for operating the HVAC system to provide space conditioning and home ventilation. Other alternatives can also be provided where steps are added, one or more steps are removed, or one or more steps are provided in a different sequence without departing from the scope of the claims herein.

What is claimed is:

1. A system for controlling solar energy utilization for efficient energy usage and conservation of energy resources, the system comprising:
a control module configured to control operation of a solar energy system associated with a building structure for providing a flow of fresh air and thermal energy converted from a solar energy source by the solar energy system;
a thermostat module disposed in the building structure to transfer signals to an HVAC system coupled with the solar energy system, the solar energy system being configured to transfer the flow of fresh air for space use of a first selected portion of the building structure and configured for ventilation of a second selected portion of the building structure, the thermostat module comprising a wireless device for transmitting temperature information to the control module via a wireless signal, the control module being substantially free from direct communication with the HVAC system; and
a graphic user interface device operably communicating with the control module remotely via a network hub, the network hub being coupled to an external network of computers, the graphic user interface device being configured to set modes of operation for the thermostat module and configured to communicate with the thermostat module for transmitting control information, modes of operation, and temperature information of the building structure to the control module via a wireless transmission.

2. The system of claim 1 wherein the solar energy system comprises a combination of one or more solar thermal modules and one or more photovoltaic modules, the solar energy system being configured to convert a solar energy source into thermal energy and to use an air plenum structure for collecting the flow of fresh air; wherein the building structure is a home; wherein the HVAC system and the solar energy system are configured to be operated in coordination with each other and free from one or more conflicts in operation; wherein the graphic user interface device comprising a plurality of programming modes.

3. The system of claim 2 wherein the solar energy system further comprises an energy transfer module coupled to the air plenum structure for receiving the flow of fresh air and providing the thermal energy carried by the flow of fresh air; wherein the conversion of the solar energy source into the thermal energy is a partial conversion of the solar energy source to the thermal energy; wherein the one or more conflicts in operation is at least one mode selected from (a) an HVAC cooling mode and a solar energy system heating mode or (b) a solar energy system cooling mode and an HVAC heating mode.

4. The system of claim 3 wherein the HVAC system comprises an air handling module coupled between the energy transfer module and the home to provide a conditioned airflow merging with the flow of fresh air for ventilation and to provide space conditioning partially utilizing the thermal energy carried by the flow of fresh air.

5. The system of claim 1 wherein the thermostat module comprises at least a touch-screen display, a temperature sensor, a wired port for directly connecting one or more control elements of the HVAC system, and a wireless port for receiving a Zigbee U-snap device.

6. The system of claim 5 wherein the control module comprises at least a USB port for inserting a Zigbee USB stick configured to mate with the Zigbee U-snap device on the thermostat module for forming a closed local wireless network.

7. The system of claim 6 wherein the thermostat module comprises an auto mode for executing pre-loaded control settings, a manual mode for inputting control settings locally via the touch-screen display, and a communication mode using the closed local wireless network for exchanging digital data with the control module.

8. The system of claim 1 wherein the graphic user interface device comprises a virtual thermostat interface capable of being operated on one or more computing devices including server computer, network computer, laptop computer, tablet computer, smartphone, flat panel display respectively connecting to the external network of computers.

9. The system of claim 8 wherein the virtual thermostat interface comprises three modes of automatic operation with pre-programmed control settings respectively for three types of occupancy states including home, sleep, and away, and a mode of manual operation for user to manually input a temperature setpoint or adjust control settings corresponding to each of the three types of occupancy states including home, sleep, and away.

10. The system of claim 8 wherein the virtual thermostat interface further comprises a graphical Round-Dial screen including an upper hemi-circle for setting a temperature setpoint associated with either the HVAC cooling mode or the HVAC heating mode initiated by the thermostat module and a lower hemi-circle for displaying a current indoor temperature and a comfort band within which the HVAC system is not initiated respectively for the three types of occupancy states including home, sleep, and away.

11. The system of claim 10 wherein the comfort band defines an adjustable range of the indoor temperature between a lower end and a higher end for either a cooling mode or a heating mode determined by the thermostat module, the lower end in the heating mode being set to be the temperature setpoint associated with the HVAC heating mode while the higher end being adjustable within the solar energy system heating mode, the higher end in the cooling mode being set to be the temperature setpoint associated with the HVAC cooling mode while the lower end being adjustable within the solar energy system cooling mode.

12. The system of claim 10 wherein the virtual thermostat interface further comprises a switch button to choose between an auto mode and a manual mode, a set of buttons to adjust the comfort band corresponding to a save-energy mode, and a tool button to open up an advanced control setting window.

13. The system of claim 12 wherein the advanced control setting window comprises a first screen display including a setting button to adjust the temperature setpoint for each of three types of occupancy states including home, sleep, and away and a second screen display including a 24/7 schedule calendar to adjust occupancy states including home, sleep, and away for each hour up to four scheduled periods per day; wherein the second screen display further includes a first button for determining when a temporary occupancy state setting overriding default settings ends, and a second button for restoring to the default settings.

14. The system of claim 8 wherein the virtual thermostat interface further comprises several tags to respectively enact control settings for different thermostat modules associated with the home.

15. A method for coordinating a solar energy system with a HVAC system for providing healthy home space conditioning and ventilation, the method comprising:
providing a control module for a solar energy system associated with a home;
disposing a thermostat device in the home for controlling a HVAC system, the thermostat device comprising a wireless device;
forming a local wireless network between the control module and the thermostat device via the wireless device;
initiating a graphic user interface for inputting control information, the graphic user interface being linked to a network hub comprising a data server configured to transfer the control information to the control module via Ethernet or Internet, the control information being partially executed by the solar energy system for providing space conditioning and ventilation;
transferring selected control information using the local wireless network from the control module to define modes of operation for the thermostat device, the modes of operation being executed by the HVAC system for providing auxiliary space conditioning;
receiving at the control module a space condition information from the thermostat device using the local wireless network; and
configuring the HVAC system and the solar energy system using the selected control information and the space condition information in a coordinated process within a defined time period, the coordinated process comprising communicating the selected control information between the control module and the graphical user interface, whereupon the communicating comprises updating the selected control information if the selected control information has been changed based on the space condition information received at the control module or the control information inputted at the graphical user interface to maintain the same updated control information at the graphical user interface, the control module, and the data server; wherein the defined time period is about fifteen minutes and less.

16. The method of claim 15 wherein the providing a control module comprises configuring the control module to control operation of the solar energy system for collecting a flow of fresh air carrying thermal energy produced by the solar energy system and delivering the flow of the fresh air to the home for providing space conditioning and home ventilation.

17. The method of claim 15 wherein the disposing a thermostat device comprises configuring the thermostat device to control the HVAC system integrated with the solar energy system for generating a conditioned airflow for providing auxiliary space conditioning.

18. The method of claim 17 wherein the coordinated process further comprises providing the flow of the fresh air using the solar energy system if the space condition information indicates that an indoor temperature is within a comfort band before providing the conditioned airflow using the HVAC system if the space condition information indicates that the indoor temperature is out of the comfort band.

19. The method of claim 18 wherein the comfort band comprises a temperature range defined for either a heating mode or a cooling mode between a lower bound value and an upper bound value adjustable via the graphic user interface for minimizing energy usage without substantially causing discomfort to occupants in the home.

20. The method of claim 19 wherein in the heating mode the upper bound value is a first setpoint that only initiates the solar energy system to provide the flow of the fresh air and is higher than the lower bound value as a default heating setpoint for providing the conditioned airflow using the HVAC system; in the cooling mode the lower bound value is a second setpoint that only initiates solar energy system to provide the flow of the fresh air and is lower than the upper bound value as a default cooling setpoint for providing the conditioned airflow using the HVAC system.
